(19) United States
(12) Patent Application Publication
(10) Pub. No.: US 2007/0211566 A1
(43) Pub. Date: Sep. 13, 2007

(54) Apparatus for mixing laboratory vessel contents with a sensor

(75) Inventors: Manfred Ebers, Bonningstedt (DE); Holger Link, Hamburg (DE); Oliver Ruser, Hamburg (DE); Ute Mahlstedt, Norderstedt (DE)

Correspondence Address: WHITE & CASE LLP;PATENT DEPARTMENT, 1155 AVENUE OF THE AMERICAS, NEW YORK, NY, 10036, US

(73) Assignee: EPPENDORF AG, Hamburg (DE)

(21) Appl. No.: 11/682,495

(22) Filed: Mar. 6, 2007

(30) Foreign Application Priority Data
Mar. 9, 2006 (DE) 10 2006 011 370.5

(51) Int. Cl. B01F 11/00

(52) U.S. Cl. 366/208

(57) ABSTRACT

According to the invention, an apparatus for mixing laboratory vessel contents, in particular, said apparatus having an accommodating adapter having a holder for accommodating vessels, in particular laboratory vessels, in particular in exchangeable thermoblocks, and a drive which can be used to put the accommodating adapter into a mixing movement which essentially oscillates in a circular and translatory manner in a horizontal plane, is distinguished by a sensor which measures a vectorial variable which is dependent on the mass of a load of the accommodating adapter.

### FIELD OF INVENTION

The present invention relates to an apparatus for mixing laboratory vessel contents, in particular, said apparatus having an accommodating adapter having a holder for accommodating vessels, in particular laboratory vessels in exchangeable thermoblocks, and a drive which can be used to put the accommodating adapter into a mixing movement which essentially oscillates in a circular and translatory manner in a horizontal plane, in particular.

### BACKGROUND OF INVENTION

Mixing apparatuses in which vessel contents are mixed are sufficiently well known. For laboratories, in particular, there are mixers which can also mix small amounts of liquid by virtue of the fact that small containers are also combined in very large groups of tens, hundreds or even thousands in suitable holders, so-called “exchangeable thermoblocks”. Such exchangeable thermoblocks as well as the reaction vessels can be standardized. For example, there are reaction vessels having a content of 0.2 ml, 0.5 ml, 1.5 ml and 2.0 ml—as well as respective suitable exchangeable thermoblocks which are standardized for the latter. In addition, there are, for example, exchangeable thermoblocks for cryo vessels, for Falcon vessels (1.5 ml and 50 ml), for glass vessels and glass beakers, for microtiter plates (MTP), for deep well plates (DWP), for slides and for PCR plates having 96 wells. This list is not exhaustive but indicates the wide variety of laboratory vessels which exist and for which the mixers should be suitable. For this purpose, there are standards and rules for the so-called “footprints”—namely the base structure of exchangeable thermoblocks.

Since these exchangeable thermoblocks are, in principle, designed in such a manner that the individual vessels are inserted into them from above, a mixing movement which oscillates in a circular and translatory manner and essentially takes place in a horizontal plane has become established for the known mixers. For this purpose, in the known mixers, an electromotive imbalance drive is generally responsible for putting a “table” into this circular movement. To this end, said table is known to be mounted in a different manner: mounting in linear rolling bearings (so-called spherical bushes) in the two horizontal directions is known, for example, but film hinge mounting is also known. Alternatively, there is also electromagnetic mounting or mounting using piezoelements which can each likewise also be used as a drive. Such mixers are usually driven at a rotational frequency of 200 rpm to 1500 rpm. It is known that the frequency of the mixing movement can be set on the basis of the mixing required for the mixing material but also on the basis of mechanical mixing parameters. It is also known that a suitable mixing frequency can be used to react to whether a particularly light or a particularly heavy load of the mixer is intended to be mixed. Alternatively, the natural frequency of the mixer can be avoided as the mixing frequency by virtue of the mixing frequency being changed somewhat if the mixer begins to “oscillate”.

### SUMMARY OF THE INVENTION

In contrast, the present invention is based on the object of providing a mixing apparatus which is even more operationally reliable.

This object is achieved by a mixing apparatus having the features of claim 1. Preferred refinements are specified in the dependent claims.

According to the invention, a mixing apparatus, in particular for laboratory vessel contents, is provided with an accommodating adapter and a drive. The accommodating adapter has a holder which is suitable for accommodating vessels. This is preferably intended to mean that the vessels can be introduced into the holder of the accommodating adapter in such a manner that they are not released by themselves during undisturbed operation during the mixing movement into which the accommodating adapter can be put using the drive. The holder of the accommodating adapter preferably meets particular standards, in particular for laboratory vessels in exchangeable thermoblocks.

The drive of the inventive mixing apparatus is capable of putting the accommodating adapter into a mixing movement which essentially oscillates in a circular and translatory manner in a plane. In other words, such an inventive mixing movement can be described by the fact that two (imaginary) points of the accommodating adapter execute a circular movement with essentially the same angular position, the same angular speed and the same radius. The mixing movement preferably takes place in a horizontal plane, with the result that an exchangeable thermoblock which is accommodated in said adapter is mixed with its reaction vessels upright.

The inventive apparatus is distinguished by a sensor which is able to measure a vectorial variable on which the mass of a load of the accommodating adapter is dependent.

According to the invention, this measurement may be static—for example using, as the inventive sensor, a weighing cell which uses strain gauges, for instance, to signal the change in mass after loading the accommodating adapter—or else dynamic—if, for example, an acceleration sensor which is based on a piezoelectric effect, for instance, measures the acceleration at least in one spatial direction during the mixing movement at a component of the inventive apparatus.

This inventive automatic determination of the mass of the load of the mixing apparatus makes it possible, according to the invention, to use suitable control apparatuses to set dynamic parameters for the mixing movement of the accommodating adapter, which mixing movement is generated by the drive. In the simple example of using a weighing cell to determine the static mass of the load according to the invention, such an inventive control apparatus can set drive parameters in such a manner that a suitable mixing movement is achieved for this mass—for example in accordance with preliminary tests—or can at least block the selection of such mixing movement parameters which could result in a fault with this load. During the measurement of dynamic acceleration, which is alternatively—or additionally—possible according to the invention, an evaluation apparatus can analyze, in particular, the temporal profile of the measured oscillation according to the invention and can also use it to determine, for example, an exceptional state, for example a defect in the drive or in the mounting of moving parts of the apparatus. In any case, such an inventive evaluation apparatus can also use the analysis of the oscillation to likewise determine the mass of the load of the accommodating adapter. Should an inventive second sensor, for example for the static direct determination of the mass of the load, also be installed in the apparatus in addition to the dynamic sensor, a comparison of the signals from these two sensors may likewise be used to draw conclusions about the operating state of the apparatus using an inventive evaluation apparatus and the appropriate information may be signaled to a control system, regulation system and/or display.

The sensor is preferably used to measure the vectorial variable in a direction normal to the plane in which the mixing movement (oscillating in a circular and translatory manner) takes place but other orientations of the sensor are also alternatively or additionally possible according to the invention. In particular, piezo acceleration sensors which measure acceleration in all three spatial directions are in mass production. Such a sensor can be used according to the invention, to be precise preferably with a main measuring direction of the sensor oriented at right angles to the plane of the mixing movement.

Further advantages and features of the present invention are described below with reference to the attached drawings which illustrate one exemplary embodiment of the invention.

### BRIEF DESCRIPTION OF DRAWINGS

FIG. 1 shows a three-dimensional view of an inventive mixing apparatus.

FIG. 2 shows a side view of the apparatus shown in FIG. 1 without the housing top part.

### DETAILED DESCRIPTION OF DRAWINGS

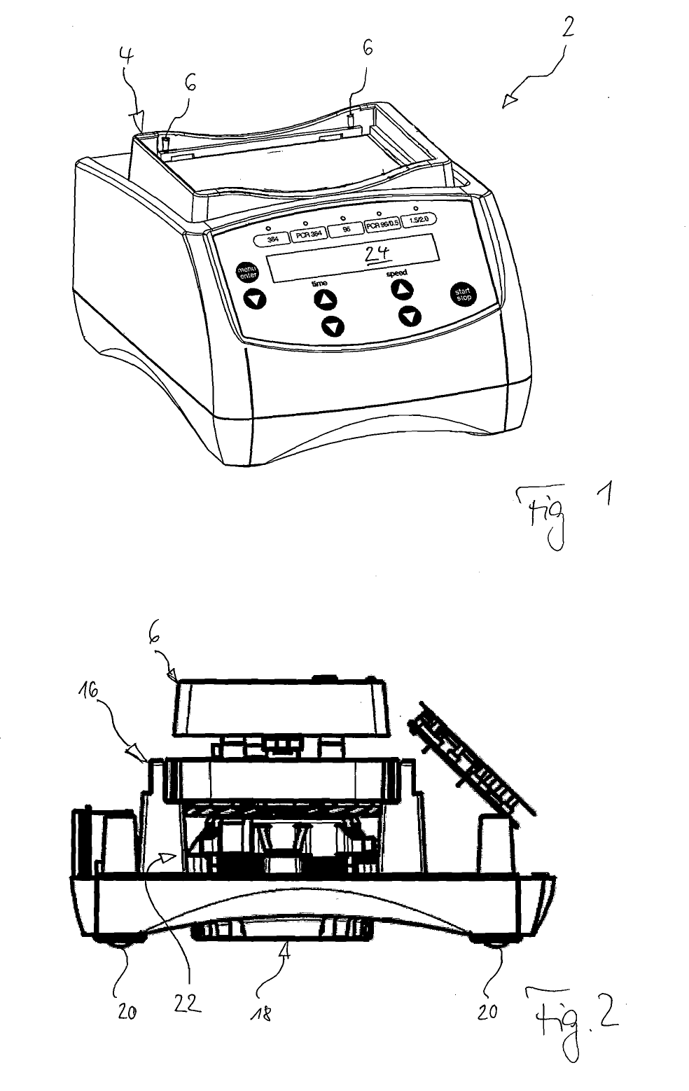

FIG. 1 reveals a mixing apparatus 2 having an accommodating adapter 4 which is on the top side, is in the form of a frame and has holders 6 for accommodating exchangeable thermoblocks.

FIG. 2 readily reveals, in the form of a side view, the internal structure of the mixing apparatus shown in FIG. 1. In particular, the accommodating adapter 6 is clearly seen above the rest of the apparatus. During operation of the apparatus 2, said adapter oscillates in a circular and translatory manner in a horizontal movement plane with respect to the chassis 16 to which the drive 18 for this mixing movement is also fastened. The side view shown in FIG. 2 also reveals that the chassis 16 stands on feet 20. The latter are elastic and comprise rubber, for example. According to the invention, it has now proven to be advantageous to install the acceleration sensor 22 on one of the other components of the apparatus which do not follow the mixing movement (to its full extent), for example on the printed circuit board itself or on adjacent housing parts, rather than on a moving component of the apparatus, that is to say, in particular, rather than on the accommodating adapter 6 itself even though the latter carries out the mixing movement. This is because these other components also oscillate above a possibly rigid base, on which the apparatus 2 stands, in reaction to the mixing movement, which oscillation is enabled, in particular, by virtue of elastic mounting on the elastic feet 20. However, this fitting of the sensor 22 to a component which is not actually driven into the mixing movement dispenses with designing the cabling of the sensor 22 to be flexible—as would be necessary if the sensor concomitantly moved.

A display 24 can be seen on the front side of the housing of the mixing apparatus 2 in FIG. 1. Different evaluation results from the analysis of the sensor signal, for example the weight of the load of the accommodating adapter 6, or an emergency signal (which can incidentally also be acoustically supplemented using a loudspeaker (not illustrated)) in the event of the mixing apparatus 2 being overloaded can be displayed on said display.

1-13. (canceled)

14. An apparatus for mixing laboratory vessel contents comprising:
an accommodating adapter including a holder configured to accommodate vessels; and
a drive configured to put the accommodating adapter into a mixing movement that oscillates in a circular and translatory manner in a horizontal plane,
a sensor configured to measure a vectorial variable which is dependent on the mass of a load of the accommodating adapter.

15. The apparatus of claim 14, wherein the holder is configured to accommodate an exchangeable thermoblock.

16. The apparatus of claim 14, wherein the sensor is configured to measure the vectorial variable in a direction normal to the horizontal plane.

17. The apparatus of claim 14, wherein the sensor is configured to measure acceleration of the apparatus during the mixing movement.

18. The apparatus of claim 14 wherein the sensor is configured to measure the oscillation of the apparatus at one of the components of the apparatus that is not put in mixing movement by the drive.

19. The apparatus of claim 18 wherein the sensor is configured to measure the oscillation of chassis of the apparatus.

20. The apparatus of claim 14 comprising elastic feet wherein the apparatus is mounted on said feet.

21. The apparatus of claim 14 wherein the sensor is a piezoelectric acceleration sensor.

22. The apparatus of claim 14 wherein the sensor is configured to measure the oscillation in the direction of the plane of the mixing movement.

23. The apparatus of claim 14 further comprising
an evaluation apparatus configured to receive a signal from the sensor,
determine an exceptional state based on the signal; and
indicate the exception state.

24. The apparatus of claim 14 wherein the sensor is configured to measure negative strain based on weight of at least one part of the apparatus that includes a load of the accommodating adapter.

25. The apparatus of claim 14 further comprising
an evaluation apparatus configured to
receive a signal from the sensor, and
determine weight of the load of the accommodating adapter.

26. The apparatus of claim 25 further comprising
a display to indicate the weight of the load.

27. The apparatus of claim 14 further comprising an emergency signal wherein said emergency signal is activated when a limiting value of the sensor is exceeded.

28. The apparatus of claim 14 further comprising an emergency disconnect wherein said emergency disconnect is activated when a limiting value of the sensor is exceeded.

29. The apparatus of claim 14 further comprising
a control apparatus configured to automatically set frequency of the mixing movement based on the measurement of the vectoral variable.

30. The apparatus of claim 14 further comprising
a control apparatus configured to automatically set amplitude of the mixing movement based on the measurement of the vectoral variable.
